(19) United States
(12) Patent Application Publication
(10) Pub. No.: US 2026/0235980 A1
(43) Pub. Date: Aug. 13, 2026

(54) IMAGE FORMING APPARATUS AND CARTRIDGE

(71) Applicant: CANON KABUSHIKI KAISHA, Tokyo (JP)

(72) Inventor: KEN YOKOYAMA, Shizuoka (JP)

(21) Appl. No.: 19/638,837

(22) Filed: Apr. 3, 2026

Related U.S. Application Data
(63) Continuation of application No. PCT/JP2024/034969, filed on Sep. 30, 2024.

(30) Foreign Application Priority Data
Oct. 6, 2023 (JP) 2023-173991

(51) Int. Cl. G03G 15/16; G03G 15/00; G03G 15/08; G03G 21/00; G03G 21/12; G03G 21/18

(52) U.S. Cl. CPC G03G 15/167; G03G 15/0808; G03G 15/0865; G03G 15/751; G03G 15/80; G03G 21/0005; G03G 21/12; G03G 21/1814

(57) ABSTRACT

An image forming apparatus forms an image on a recording material. The apparatus includes a photosensitive drum bearing a toner image, a frame rotatably supporting the drum, a sheet member having a free end and another end fixed to the frame, and a transfer roller contacting the drum to form a transfer nip and transferring the toner image onto the recording material passing through the transfer nip. The sheet member includes a conductive layer and an insulating layer and is disposed downstream of the transfer nip in a conveyance direction. When viewed in a thickness direction, the layers at least partially overlap, and the insulating layer is closer to the drum than the conductive layer and faces a surface of the drum.

### CROSS-REFERENCE TO RELATED APPLICATIONS

This application is a Continuation of International Patent Application No. PCT/JP2024/034969, filed Sep. 30, 2024, which claims the benefit of Japanese Patent Application No. 2023-173991, filed Oct. 6, 2023, both of which are hereby incorporated by reference herein in their entirety.

### BACKGROUND

### Field of the Technology

The present disclosure relates to an image forming apparatus that forms an image on a recording material, and a cartridge.

### Description of the Related Art

An image forming apparatus that transfers a toner image onto a recording material by passing the recording material through a transfer portion so as to overlap the toner image borne on an image bearing member such as a photosensitive drum is widely used.

When a toner image is transferred onto a recording material, conveyed paper as the recording material may electrostatically adhere to a surface of a photosensitive drum depending on a configuration of the photosensitive drum or other surrounding components. Accordingly, Japanese Patent Laid-Open No. 2009-175283 describes a configuration in which a separation member such as a separation pawl is brought into contact with a surface of a photosensitive drum to mechanically separate the conveyed sheet from the photosensitive drum.

### SUMMARY

The present disclosure is directed to providing a new form of an image forming apparatus.

According to an aspect of the present disclosure, an image forming apparatus that forms an image on a recording material includes a photosensitive drum configured to bear a toner image, a frame configured to rotatably support the photosensitive drum, a sheet member having one end that is a free end and another end fixed to the frame, and a transfer roller configured to contact the photosensitive drum to form a transfer nip and configured to transfer the toner image onto the recording material when the recording material is conveyed and passes through the transfer nip, wherein the sheet member includes a conductive layer and an insulating layer and is provided on a downstream side in a conveyance direction of the recording material at the transfer nip, wherein, when viewed in a thickness direction of the sheet member, the conductive layer and the insulating layer overlap at least partially, and wherein the insulating layer is closer to the photosensitive drum than the conductive layer and is disposed to face a surface of the photosensitive drum.

Features of the present disclosure will become apparent from the following description of embodiments with reference to the attached drawings.

### BRIEF DESCRIPTION OF THE DRAWINGS

FIG. 1 is a cross-sectional view of an image forming apparatus.

FIG. 2 is a cross-sectional view of a developing unit according to the present disclosure.

FIG. 3 is a perspective view of the developing unit according to the present disclosure.

FIG. 4 is a cross-sectional view of the developing unit mounted on a photosensitive member unit.

FIG. 5 is a perspective view of a process cartridge according to the present disclosure.

FIG. 6 is a perspective view of the developing unit and the photosensitive member unit according to the present disclosure.

FIG. 7A is an enlarged cross-sectional view of an image forming portion of the process cartridge according to a first embodiment.

FIG. 7B is another enlarged cross-sectional view of the image forming portion of the process cartridge according to the first embodiment.

FIG. 8A is a schematic view of a conductive sheet according to the first embodiment.

FIG. 8B is another schematic view of the conductive sheet according to the first embodiment.

FIG. 9A is a schematic view of a conductive sheet according to a second embodiment.

FIG. 9B is another schematic view of the conductive sheet according to the second embodiment.

FIG. 9C is still another schematic view of the conductive sheet according to the second embodiment.

FIG. 10 is an enlarged cross-sectional view of an image forming portion of a process cartridge according to a third embodiment.

FIG. 11A is an enlarged cross-sectional view of an image forming portion of a process cartridge according to a fourth embodiment.

FIG. 11B is another enlarged cross-sectional view of the image forming portion of the process cartridge according to the fourth embodiment.

### DESCRIPTION OF THE EMBODIMENTS

Embodiments according to the present disclosure will be described below with reference to the drawings.

### First Embodiment

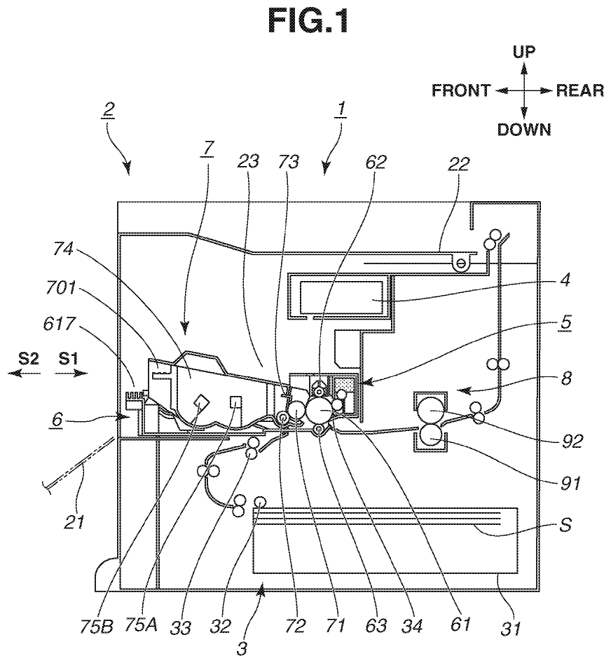

An image forming apparatus according to a first embodiment of the present disclosure will be described in detail below with reference to the drawings as appropriate. FIG. 1 is a sectional view of an image forming apparatus 1.

In the following description, directions are defined with reference to a user who uses the image forming apparatus 1. Specifically, a front side of the image forming apparatus 1 is referred to as “front”, a rear side of the image forming apparatus 1 is referred to as “rear”, a top (upper surface) side of the image forming apparatus 1 is referred to as “up”, and a bottom (lower surface) side of the image forming apparatus 1 is referred to as “down”. Further, when the image forming apparatus 1 is viewed from the front side, a left side of the image forming apparatus 1 is referred to as “left”, and a right side of the image forming apparatus 1 is referred to as “right”. The directions in each drawing are defined by arrows indicated in the drawing.

A front-rear direction, an up-down direction, and a left-right direction indicated by the arrows are directions orthogonal to each other. These directions indicate the same directions in all drawings. The up-down direction is parallel to a vertical direction, and the left-right direction and the front-rear direction are parallel to a horizontal direction. Further, the left-right direction is parallel to a rotation axis direction of a photosensitive drum 61 and is also parallel to a rotation axis direction of a developing roller 71. Further, an integrated unit obtained by mounting a developing unit (developing cartridge) 7 to a photosensitive member unit (drum cartridge) 6 is referred to as a process cartridge (cartridge) 5. The process cartridge 5 is inserted in an arrow S1 direction in the drawing (mounting direction) when the process cartridge 5 is mounted to an apparatus main body 2, and the process cartridge 5 is removed in an arrow S2 direction in the drawing.

### <Configuration of Image Forming Apparatus>

As illustrated in FIG. 1, the image forming apparatus 1 that forms an image on a recording material mainly includes a sheet feeding unit 3 for supplying a sheet S (recording material) into the apparatus main body 2, an exposure device 4, the process cartridge 5 that transfers toner as a developer onto the sheet S as a toner image, and a fixing device 8 that thermally fixes the toner image transferred onto the sheet S. The sheet feeding unit 3 is provided in a lower portion of the apparatus main body 2, and mainly includes a sheet feeding tray 31 and a sheet feeding mechanism 32.

The exposure device 4 is disposed in an upper portion of the apparatus main body 2 and includes a laser light-emitting portion (not illustrated) and a polygon mirror, a lens, a reflecting mirror, and the like which are illustrated without reference numerals. In the exposure device 4, a laser beam based on image data and emitted from the laser light-emitting portion scans a surface of the photosensitive drum 61 at high speed, thereby exposing the surface of the photosensitive drum 61.

The process cartridge 5 is disposed below the exposure device 4. The process cartridge 5 is inserted in the arrow S1 direction into a housing portion 23 of the apparatus main body 2 through an opening formed when a door (opening/closing member) 21 provided on the apparatus main body 2 is opened (represented by a two-dot chain line in FIG. 1), so that the process cartridge 5 is mounted to the apparatus main body 2. When the process cartridge 5 is removed from the apparatus main body 2, the process cartridge 5 is moved in the arrow S2 direction to be taken out. In this manner, the process cartridge 5 is configured to be attachable to and detachable from the apparatus main body 2 of the image forming apparatus 1.

The process cartridge 5 mainly includes a photosensitive member unit 6 and a developing unit 7. The photosensitive member unit 6 mainly includes the photosensitive drum 61, a charging roller 62, and a transfer roller 63. The developing unit 7 is configured to be detachably mounted to the photosensitive member unit 6. The developing unit 7 includes the developing roller 71, a supply roller 72, a layer thickness regulating blade 73, a toner container portion (developer container portion) 74 that contains the toner (the developer), and a first stirring member 75A and a second stirring member 75B provided in the toner container portion 74.

### <Configuration of Process Cartridge>

Next, each unit of the process cartridge 5 will be described. The process cartridge 5 includes the photosensitive member unit 6 and the developing unit 7 detachably mountable to the photosensitive member unit 6.

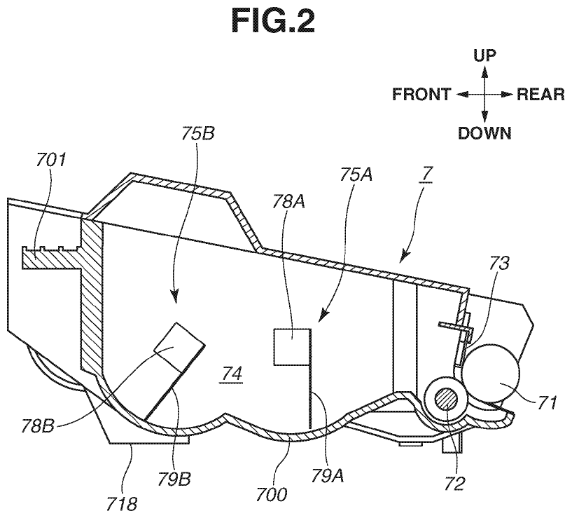

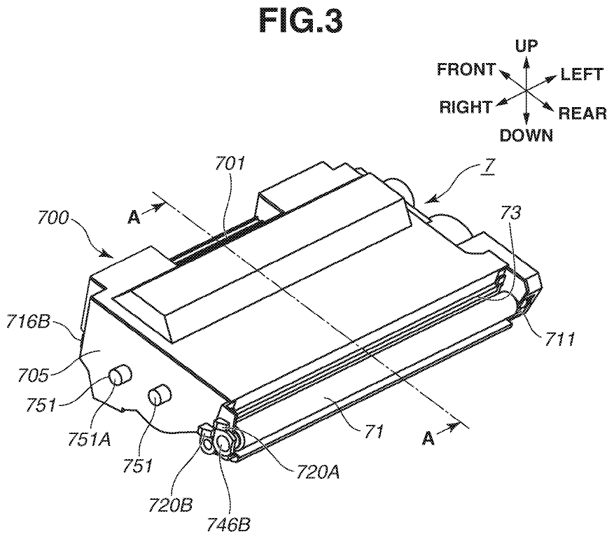

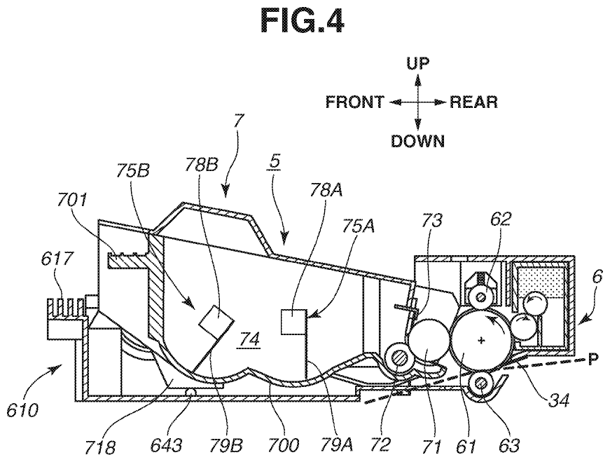

First, a configuration of the developing unit 7 will be described with reference to FIGS. 2, 3, and 7A and 7B. FIG. 2 is a sectional view of the developing unit 7 and is a cross-sectional view taken along line A-A of FIG. 3 described below. FIG. 3 is a perspective view of the developing unit 7 viewed from above. FIG. 4 is a sectional view of the developing unit 7 mounted to the photosensitive member unit 6, and the cross section is parallel to the up-down direction and the front-rear direction.

As illustrated in FIG. 2, the developing unit 7 includes a grip portion 701 to be gripped by a user on a front side of a housing (second frame) 700 serving as a developing frame, and the developing roller 71 is rotatably supported on a rear side of the housing 700. In the following description regarding the configuration of the developing unit 7, the rotation axis direction of the developing roller 71 is referred to as an axial direction.

As illustrated in FIGS. 2 and 3, the developing unit 7 includes a first electric contact 720A electrically connected to the developing roller 71 and supplied with a voltage to be applied to the developing roller 71, and also includes a second electric contact 720B electrically connected to the supply roller 72 and supplied with a voltage to be applied to the supply roller 72. With each of these electric contacts in contact with a power supply contact (not illustrated) provided on the apparatus main body 2, electric power is supplied to the developing roller 71 and the supply roller 72.

In conjunction with an operation of closing the door 21 provided on the apparatus main body 2, a developing drive transmission member (not illustrated) provided on the apparatus main body 2 moves to a position to engage with a developing coupling (not illustrated). Conversely, in conjunction with an operation of opening the door 21, the developing drive transmission member moves to a position to release the engagement with the developing coupling (not illustrated). In this manner, the drive transmission mechanism from the apparatus main body 2 to the process cartridge 5 via the developing unit 7 is configured.

The developing unit 7 employs the two stirring members, namely the first stirring member 75A and the second stirring member 75B, to stir the toner in the toner container portion 74. The first stirring member 75A includes a stirring rod 78A and a stirring sheet 79A. The second stirring member 75B includes a stirring rod 78B and a stirring sheet 79B. The second stirring member 75B supplies the toner in the toner container portion 74 toward the first stirring member 75A. The toner near the first stirring member 75A in the toner container portion 74 is stirred by the first stirring member 75A, and supplied toward the supply roller 72, and further supplied to the developing roller 71 by the supply roller 72.

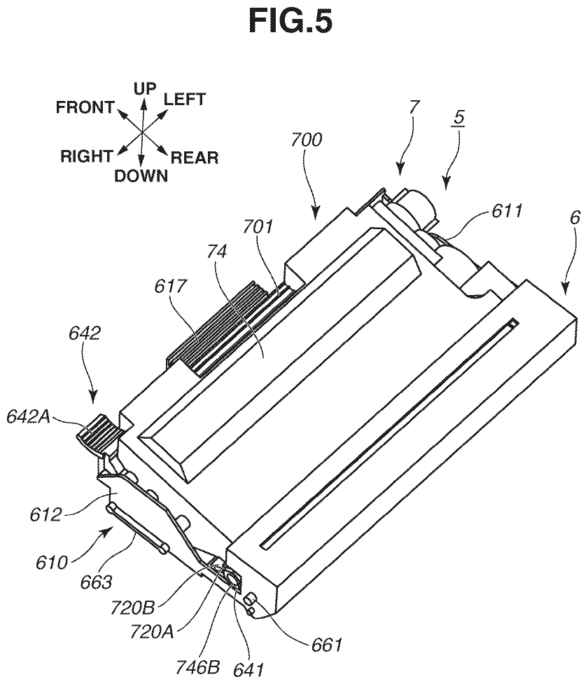

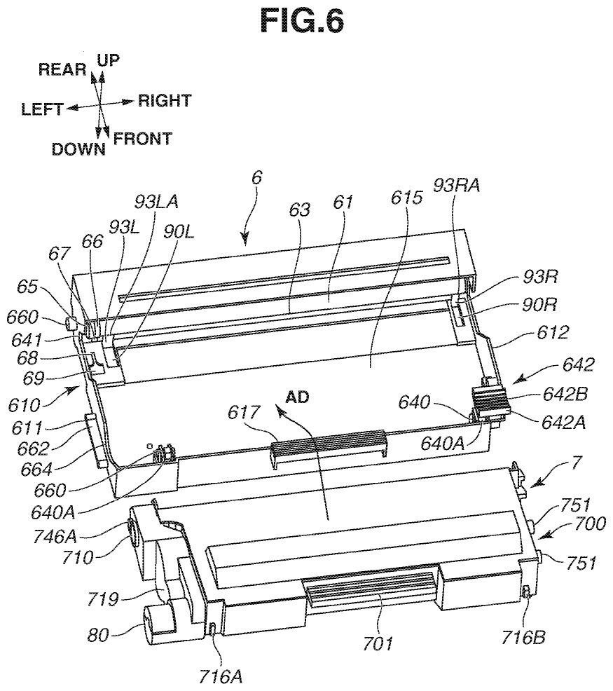

Next, a detailed configuration of the photosensitive member unit 6 will be described with reference to FIGS. 4, 5, and 6. FIG. 5 is a perspective view of the process cartridge 5. FIG. 6 is a perspective view of the developing unit 7 and the photosensitive member unit 6.

As illustrated in FIG. 4, the photosensitive member unit 6 mainly includes the photosensitive drum 61, the charging roller 62, and the transfer roller 63. As illustrated in FIGS. 5 and 6, the photosensitive member unit 6 mainly includes a frame (first frame) 610 having a pair of a left side wall 611 and a right side wall 612, and the photosensitive drum 61 rotatably supported on a rear side of a frame 610. In the present embodiment, the photosensitive drum 61 has a diameter of 30 mm. On a front side of the frame 610, the frame 610 includes a mounting portion 615 to which the developing unit 7 is mountable, a grip portion 617 by which a user grips the photosensitive member unit 6, pressing members 640 that press the developing unit 7, and a lift member (moving member) 642 that lifts the developing unit 7. The lift member 642 lifts the developing unit 7 mounted to the mounting portion 615. In the left-right direction, the toner container portion 74 of the developing unit 7 mounted to the mounting portion 615 is disposed between the left side wall 611 and the right side wall 612.

Further, as illustrated in FIG. 6, a photosensitive gear 65 and a transfer gear 66 are fixed to a left end portion of the photosensitive drum 61, and rotate integrally with the photosensitive drum 61. When the process cartridge 5 is mounted to the apparatus main body 2, a drive gear (not illustrated) of the apparatus main body 2 meshes with the photosensitive gear 65 to transmit driving force that allows the photosensitive drum 61 and the transfer gear 66 to rotate. Further, the transfer gear 66 meshes with a transfer roller gear 67 fixed to a left end portion of the transfer roller 63, so that the transfer roller 63 is also made rotatable.

Here, the photosensitive drum 61 includes a support and a photosensitive layer. The support is a conductive support having conductivity, and in the present embodiment, an aluminum support is used.

A service life of the developing unit 7, which is determined by an amount of the toner stored in the developing unit 7, is set to be shorter than a service life of the photosensitive member unit 6. Accordingly, only the developing unit 7 that has reached its service life needs to be replaced separately from the photosensitive member unit 6. In such a case, the door 21 is opened, the process cartridge 5 is taken out from the apparatus main body 2, the developing unit 7 that has reached its service life is removed from the photosensitive member unit 6, and another developing unit 7 is attached to the photosensitive member unit 6 in a mounting direction AD illustrated in FIG. 6. Thereafter, the photosensitive member unit 6 to which the developing unit 7 is mounted is mounted to the apparatus main body 2 as the process cartridge 5.

### <Image Forming Process>

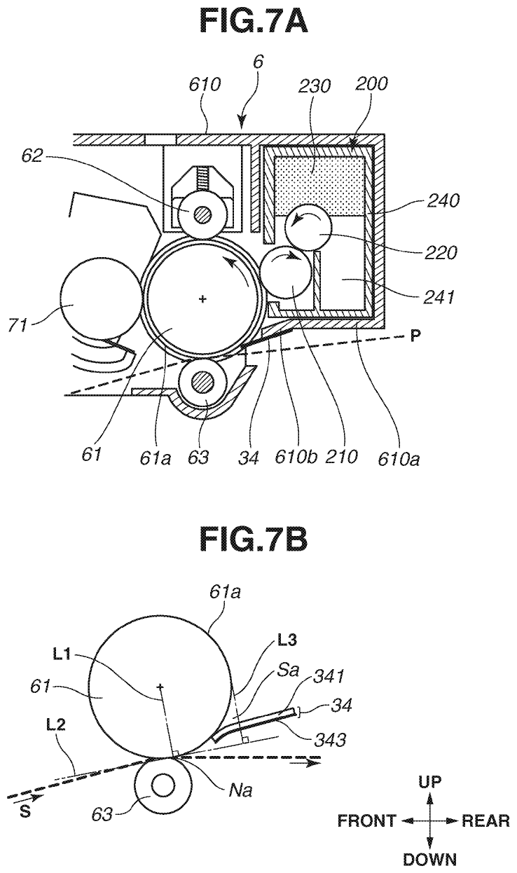

Next, an image forming process will be described with reference to FIGS. 1, 4, and 7A. FIG. 7A is an enlarged sectional view illustrating an image forming portion of the process cartridge 5 according to the present embodiment.

The photosensitive drum 61 is rotationally driven during execution of the image forming process. First, a surface of the photosensitive drum 61 is uniformly charged by the charging roller 62 serving as a charging member, and thereafter the surface of the photosensitive drum 61 is exposed to a laser beam corresponding to image data emitted from the exposure device 4, thereby forming an electrostatic latent image corresponding to the image data on the photosensitive drum 61. In the present embodiment, a voltage applied to the charging roller 62 has a positive polarity, and the surface of the photosensitive drum 61 is charged to the positive polarity.

The toner in the toner container portion 74 is stirred by the second stirring member 75B and the first stirring member 75A, and is then supplied to the developing roller 71 via the supply roller 72. The toner supplied to the developing roller 71 enters between the developing roller 71 and the layer thickness regulating blade 73 and is borne on the developing roller 71 as a thin layer having a predetermined thickness. In this manner, the developing roller 71 functions as a developer bearing member that bears toner serving as a developer.

The toner borne on the developing roller 71 is supplied to the electrostatic latent image formed on the photosensitive drum 61. Accordingly, the toner adheres to the electrostatic latent image to form a visible image, and a toner image is formed on the photosensitive drum 61.

Meanwhile, the sheet S stored in the sheet feeding tray 31 is fed by the sheet feeding mechanism 32 and is guided by conveyance rollers 33 into a conveyance path formed by a frame of the photosensitive member unit 6 and the housing 700 of the developing unit 7. A broken line in FIG. 4 represents the conveyance path P. The sheet S passes through the conveyance path P and is conveyed to a position between the photosensitive drum 61 and the transfer roller 63 (a transfer nip N).

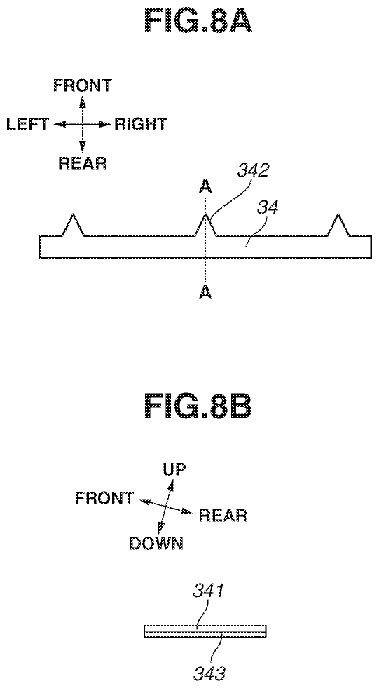

A desired transfer voltage is applied to the transfer roller 63 serving as a transfer member by a voltage applying unit (not illustrated), and the toner image (the developer image) on the photosensitive drum 61 is transferred onto the sheet S in the transfer nip N. A conductive sheet 34, which functions as a separation pawl 34 that mechanically separates the sheet S from the photosensitive drum 61 is disposed downstream of the transfer nip N in a paper conveyance direction. A configuration of the conductive sheet 34 is specific to the present embodiment and will be described below in detail with reference to FIGS. 8A and 8B. In the present embodiment, a voltage applied to the transfer roller 63 has a negative polarity.

The sheet S after the transfer is conveyed to the fixing device 8 disposed behind the process cartridge 5. The fixing device 8 includes a heating roller 92 and a pressure roller 91 as fixing members. The sheet S onto which the toner image has been transferred passes through the fixing device 8, and, at that time, the sheet S is heated and pressed between the heating roller 92 and the pressure roller 91, so that the toner image is fixed on the sheet S. The sheet S that has passed through the fixing device 8 is discharged onto a discharge tray 22.

Next, a cleaning unit 200 that mainly removes foreign matter on a surface 61a of the photosensitive drum 61 will be described with reference to FIGS. 7A and 7B. The cleaning unit 200 is fixed to the frame 610 of the photosensitive member unit 6. The cleaning unit 200 includes a cleaning roller (a cleaning member) 210 serving as a first collecting member that collects foreign matter from the surface 61a of the photosensitive drum 61 by rotating while being in contact with the surface 61a of the photosensitive drum 61. The cleaning unit 200 also includes a collection roller 220 serving as a second collecting member that collects, from the cleaning roller 210, foreign matter collected by the cleaning roller 210 by rotating while being in contact with a surface of the cleaning roller 210. The cleaning unit 200 further includes a scraping member (e.g., a sponge) 230 provided to be slidable against the rotating collection roller 220 and configured to scrape foreign matter from the collection roller 220. The cleaning unit 200 further includes a foreign matter storage portion 241 serving as a storage portion that forms a storage space for accommodating foreign matter, and foreign matter scraped off by the scraping member 230 is stored in the foreign matter storage portion 241.

Meanwhile, most of the residual transfer toner remaining on the photosensitive drum 61 without being transferred passes through a contact point between the photosensitive drum 61 and the cleaning unit 200, is collected by the developing roller 71, and is returned to the developing unit 7.

### <Configuration Specific to Present Embodiment>

Next, a configuration specific to the present embodiment will be described in detail with reference to FIGS. 7A and 7B, and 8A and 8B.

FIG. 7B is a diagram illustrating, in detail, main members near the transfer nip extracted from FIG. 7A in order to describe a tip position of a conductive sheet (sheet member) 34 serving as a conductive member. FIG. 8A is a schematic diagram of the conductive sheet 34, and FIG. 8B is a sectional view taken along line A-A of the conductive sheet 34.

The conductive sheet 34 is an elastic sheet and consists of a resin sheet 341 serving as an insulating layer and a metal film 343 serving as a conductive layer, and the resin sheet 341 is attached to a lower surface 610b of the frame 610 with double-sided tape. A plurality of separation pawls 342, each of which is a protrusion that makes point contact with the surface 61a of the photosensitive drum 61, is provided in a frontward portion of the resin sheet 341, and the separation pawls 342, each of which is also an elastic member, are pressed against and brought into contact with the surface 61a of the photosensitive drum 61 as illustrated in FIG. 7B, thereby mechanically separating the sheet S from the surface 61a of the photosensitive drum 61. That is, the conductive sheet 34 has one end fixed to the frame 610 and another end that is a free end.

Here, the resin sheet 341 is a polyester (polyethylene terephthalate (PET)) sheet having a thickness of 80 μm, and the metal film 343 is an aluminum vapor-deposited film having a thickness of about 0.2 μm. A thickness of the polyester (PET) sheet may be 40 μm or more and 200 μm or less, and a thickness of the aluminum vapor-deposited film may be 0.1 μm or more and 0.5 μm or less. Thus, in the present embodiment, the conductive sheet 34 may be regarded as having, when viewed in a thickness direction, an overlapping portion where the aluminum vapor-deposited film serving as the conductive layer and the polyester sheet serving as the insulating layer overlap at least partially.

The tip position of the conductive sheet 34 is disposed within a region Sa surrounded by a broken line L2 (a first imaginary line), a broken line L3 (a second imaginary line), and an outer circumference of the surface 61a of the photosensitive drum 61. Here, the broken line L2 is a tangent line to the photosensitive drum 61 at a downstream end portion (a downstream end point) Na of the transfer nip. Further, the broken line L3 is a line that is perpendicular to the broken line L2 on a downstream side of the transfer nip and is a tangent line to the photosensitive drum 61.

Further, the metal film 343 serving as the conductive layer is electrically connected to the support of the photosensitive drum 61 of the photosensitive member unit 6 and is configured to have the same potential as the support of the photosensitive drum 61. In this configuration, the support of the photosensitive drum 61 is a cylindrical aluminum cylinder. Further, when the process cartridge is mounted to the apparatus main body 2, the support of the photosensitive drum 61 is electrically grounded to the apparatus main body 2.

In a transfer process, a negative transfer voltage is applied to the conveyed sheet S by the transfer roller 63 at the transfer nip N, and the sheet S is negatively charged. Meanwhile, the surface 61a of the photosensitive drum 61 is positively charged, and, on a downstream side of the transfer nip N, the sheet S is attracted toward the photosensitive drum 61 due to a potential difference between the negatively charged sheet S and the positively charged surface 61a of the photosensitive drum 61. In order to prevent the sheet S discharged from the transfer nip from contacting the frame 610, the tip position of the conductive sheet 34 needs to be disposed at least above the broken line L2. Further, the tip position of the conductive sheet 34 is disposed closer to the surface 61a of the photosensitive drum 61 than the broken line L3, which is a region where an electric field from the photosensitive drum 61 affects the sheet S.

Accordingly, in order to stably convey the sheet S while reducing an electrostatic force between the sheet S and the photosensitive drum 61, the tip position of the conductive sheet 34 is disposed in a region Sa near the surface 61a of the photosensitive drum 61, the region Sa being closer to the surface 61a of the photosensitive drum 61 than the broken line L2 and also being closer to the surface 61a of the photosensitive drum 61 than the broken line L3. In this state, when viewed from the rotation axis direction of the photosensitive drum 61, at least a part of the conductive layer overlaps the region Sa.

As described above, in the present disclosure, the conductive sheet 34 is included that is disposed near the surface 61a of the photosensitive drum 61, and a potential of the conductive sheet 34 is the same as a potential of the support of the photosensitive drum 61. When a potential difference between the negatively charged sheet S and the positively charged surface 61a of the photosensitive drum 61 is compared with a potential difference between the negatively charged sheet S and a potential of the metal film 343, which is the potential of the support of the photosensitive drum 61, the latter is smaller and thus an electric field is also weaker. Accordingly, an electrostatic force acting on the sheet S is weakened, and it is possible to suppress an image defect in which a printed surface of the sheet S contacts the collection container and the contact disturbs a toner image on the sheet S, and also to suppress occurrence of an issue in which members on the downstream side of the photosensitive member unit are contaminated with toner.

An experiment was conducted to verify the effects of the present embodiment. A resin sheet having the conductive layer 343 and a resin sheet not having the conductive layer 343 were prepared, each resin sheet was attached to a photosensitive member unit, and the two photosensitive member units were prepared. Evaluation paper was A4-size CS-052 manufactured by Canon, and a sheet passing test was conducted in an environment at a temperature of 15° C. and a humidity of 10%. The evaluation paper was selected because the evaluation paper has low stiffness and tends to be attracted toward the photosensitive drum. As an evaluation pattern, thin lines in the left-right direction (the photosensitive drum rotation axis direction) each having a width of about 0.1 mm were printed over an entire surface at intervals of 10 mm, and image disturbance due to rubbing with a lower surface of the photosensitive member unit was checked. Further, an image was output by an external power supply applying transfer voltages from 1 kV to 3 kV in increments of 0.5 kV.

Evaluation ranks were defined such that rank A indicates no image disturbance, rank B indicates image rubbing on two lines or less, rank C indicates image rubbing on five lines or less, rank D indicates image rubbing on 15 lines or less, and rank E indicates image rubbing on 16 lines or more. Table 1 lists the results of checking image disturbance.

TABLE 1

| | | Transfer voltage [kV] | | | | |
|---|---|---|---|---|---|---|
| | | 1.0 | 1.5 | 2.0 | 2.5 | 3.0 |
| With/without | Without | A | A | B | C | D |
| conductive | With | A | A | A | A | A |
| layer 343 | | | | | | |

As indicated in Table 1, in the comparative example without the conductive layer 343, image disturbance tends to worsen as the transfer voltage is increased. This tendency results from an increase in an amount of charge on the sheet due to the increase in the transfer voltage, and the increased amount of charge causes the sheet to receive a larger electrostatic force, thereby making the sheet more likely to be attracted toward the photosensitive drum 61.

Further, in the configuration including the conductive layer 343 according to the present embodiment, the electrostatic force acting on the sheet is weakened by the effect of the present embodiment, and thus image disturbance does not occur.

Here, the material of the resin sheet 341 is not limited to polyester, and examples of the elastic resin sheet include a polyethylene naphthalate resin sheet, a polycarbonate sheet, a polyvinylidene fluoride (PVDF) sheet, a polyethylene sheet, a polypropylene sheet, a polystyrene sheet, a polyamide sheet, a polyarylate polyethylene naphthalate sheet, a polybutylene naphthalate sheet, and a thermoplastic polyimide sheet.

Meanwhile, a resin sheet 341 made of an insulator may cause a memory image to occur due to sliding contact with the photosensitive drum 61. The memory image occurs because the resin sheet 341 is excessively charged by sliding contact with the photosensitive drum 61 and the charged electricity is discharged from the resin sheet 341 to the photosensitive drum 61. As a countermeasure against the memory image, adjusting a resistance value of the resin sheet 341 by the material is effective. For example, carbon black is dispersed as an electrical resistance adjusting agent to provide a high-resistance sheet having a volume resistivity of 10⁸ Ω·cm or more, thereby making it possible to prevent the memory image.

The material of the conductive layer 343 is not limited to aluminum, and any material may be used as long as the material is a conductive metal film. A manufacturing method is not limited to vapor deposition described as an example, and a sputtering method or a chemical vapor deposition (CVD) method may be used.

Further, a conductive layer serving as a conductor having a medium-to-low resistivity as a surface resistivity of 1.00×10⁶ Ω/sq or less can be expected to have the effect. A thickness of a metal film may be reduced as long as this medium-to-low resistivity value is satisfied. Alternatively, the conductive layer 343 may be configured by coating a curable resin to which conductive filler such as carbon black described above is added.

The cleaning unit 200 needs to collect foreign matter throughout the service life of the photosensitive member unit 6. An amount of foreign matter to be collected varies depending on a service life setting of the photosensitive member unit 6, and thus, in a case where the service life of the photosensitive member unit 6 is set to be long, a capacity of the foreign matter storage portion 241 needs to be increased accordingly. If the foreign matter storage portion 241 is expanded rearward in the front-rear direction, the photosensitive member unit 6 may become larger in the rear direction, and a conveyance path between the transfer portion and the fixing portion may become longer. This may affect a conveyable sheet size and may also affect a size of the apparatus main body 2. Further, if the foreign matter storage portion 241 is expanded downward in the up-down direction, a lower surface (a transfer downstream lower portion) 610a of the frame 610 of the photosensitive member unit 6 approaches the conveyance path, increasing a risk of disturbing an image due to contact with the transfer downstream lower portion 610a. From these considerations, the configuration of the present embodiment is effective particularly for a photosensitive member unit having a long service life.

In FIG. 8A, three contact positions of the conductive sheet 34 are provided in a longitudinal direction, but the number of contact positions is not limited to the example. Further, in the present embodiment, a method of fixing the conductive sheet 34 to the photosensitive member unit 6 is described using double-sided tape, but the method is not limited to the example.

In FIG. 8A, in the range in which the conductive sheet 34 is provided in the direction of the rotation axis of the photosensitive drum, the conductive sheet 34 is in contact with a surface of the photosensitive drum at a first position, which is a contact position. Further, at a second position, which is a non-contact position, the conductive sheet 34 is not in contact with any surface of the photosensitive drum.

Further, as the scraping member, a blade made of an elastic material such as rubber may be used instead of the sponge 230.

In the present embodiment, a position of a tip of the conductive sheet 34 has been defined, but an arrangement can also be defined for a portion other than the tip. Specifically, in a region from the broken line L3 to the photosensitive drum 61, disposing a portion other than the tip of the conductive sheet 34 above the broken line L2 reduces a risk that the sheet S contacts the conductive sheet 34.

A desirable form of disposing the tip of the conductive sheet 34 has been described above, and, in the description, the region Sa has been defined with the downstream end portion Na of the transfer nip N as an origin. In the present embodiment in which the frame 610 of the photosensitive member unit 6 supports the transfer roller 63, variation in a position of the downstream end portion Na of the transfer nip on the photosensitive drum can be reduced. Accordingly, a degree of freedom in disposition of the conductive sheet 34 in the desired region Sa increases. Needless to say, although a degree of freedom in the disposition decreases in a configuration in which the apparatus main body includes the transfer roller, disposing the conductive sheet 34 in the region Sa achieves similar effects.

As described above, it is possible to prevent the conveyed sheet from passing near the photosensitive drum due to an electrostatic force that attracts the conveyed sheet toward the photosensitive drum after the conveyed sheet is mechanically separated from the photosensitive drum. This configuration is particularly effective for thin paper which is likely to be attracted toward the photosensitive drum. This configuration is also suitable for a case where a collecting unit that collects residual transfer toner and foreign matter and a collection container that stores collected toner are disposed on a photosensitive drum side downstream of a transfer portion. It is possible to effectively prevent an image defect in which a printed surface of the conveyed sheet discharged near the photosensitive drum from the transfer portion contacts the collection container and then a toner image on the conveyed sheet is disturbed, and also to effectively prevent the issue that members located downstream of the photosensitive drum are contaminated with toner.

Since the portion that contacts the photosensitive drum is insulative, uneven charging that would occur when a conductive object contacts the photosensitive drum also does not occur. Uneven charging may cause a phenomenon that the photosensitive drum is not uniformly recharged in a charging process, which is a post-process in the image forming process. In such a case, an image defect may become apparent as a memory image. However, the present embodiment can effectively prevent such a phenomenon.

Even when a conveyed sheet electrostatically adheres to the surface 61a of the photosensitive drum, which is an image bearing member, the conveyed sheet can be reliably separated without passing through a gap between the conductive sheet and the photosensitive drum since the tip of the conductive sheet is in contact with the photosensitive drum. Further, since the metal film is disposed close to the photosensitive drum, an electrostatic force that attracts the conveyed sheet toward the photosensitive drum after the separation is weakened.

Accordingly, in the present embodiment, both mechanical separation of the conveyed sheet from the photosensitive drum and reduction of the electrostatic force attracting the conveyed sheet toward the photosensitive drum can be achieved. As a result, it is possible to prevent an image defect in which by the conveyed sheet being attracted by the electrostatic force, a printed surface contacts a collection container, and a toner image on the sheet is disturbed, and also to suppress occurrence of an issue that members on a downstream side of the photosensitive drum are contaminated with toner.

### Second Embodiment

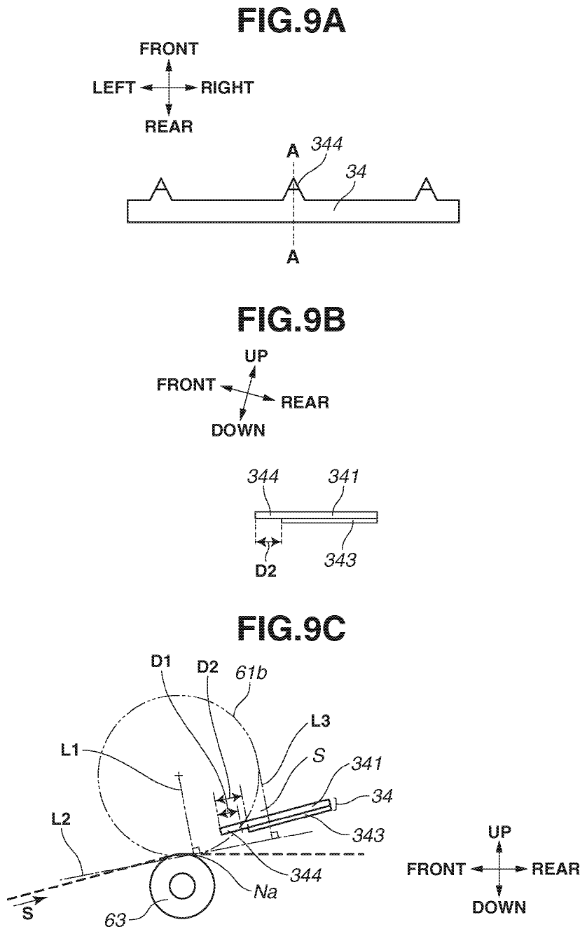

A second embodiment will be described with reference to FIG. 9A to FIG. 9C. FIG. 9A to FIG. 9C illustrate a conductive sheet 34, which is a conductive member characteristic of the present embodiment and also a separation pawl. FIG. 9A is a view of the conductive sheet viewed from below, FIG. 9B is a sectional view taken along line A-A of FIG. 9A, and FIG. 9C is a diagram illustrating, in detail, main members near the transfer nip that have been extracted in order to describe a vicinity of a tip of the conductive sheet 34.

In the present embodiment, the conductive layer 343 is prevented from contacting the photosensitive drum through sliding friction and wear of a resin sheet 341 of the conductive sheet 34 as the photosensitive member unit 6 is used.

A separation pawl, which is a tip of the conductive sheet 34 that contacts and slides against a surface 61a of the photosensitive drum 61, undergoes progression of resin wear with the use. In a shape illustrated in FIG. 8A and FIG. 8B of the first embodiment, when wear progresses and the conductive layer 343 contacts the photosensitive drum 61, charge on a surface layer of the photosensitive drum 61 may leak to a base material of the photosensitive drum 61 via the conductive layer 343. As a result, uneven charging may occur between a portion where the conductive sheet 34 serving as the separation pawl contacts the photosensitive drum 61 and a portion where the conductive sheet 34 does not contact the photosensitive drum 61. When this uneven charging causes a phenomenon that the photosensitive drum is not uniformly recharged in a charging process, which is a post-process, an image defect becomes apparent as a memory image.

The present embodiment is directed to preventing contact of the conductive layer 343 with the photosensitive drum 61 by providing an exposed portion 344 of the resin sheet as illustrated in FIGS. 9A to 9C, and to prevent leakage of charge from the conductive layer 343 to the photosensitive drum 61 that causes a memory image.

An example of the exposed portion 344 will be described in detail with reference to FIGS. 9B and 9C. FIG. 9C illustrates a state in which the photosensitive drum is removed from the photosensitive member unit of the present embodiment, and a surface 61b of an imaginary photosensitive drum is represented by a broken line. Since there is no photosensitive drum that contacts the conductive sheet 34, the conductive sheet 34 enters the imaginary photosensitive drum straight. Here, a distance by which the conductive sheet 34 enters the surface 61b of the photosensitive drum is defined as an entering amount D1 (or Distance D1). Meanwhile, as illustrated in FIG. 9B, a distance from a tip of the exposed portion 344 to the conductive layer 343 is defined as D2, and a relationship between the distance D1 and the distance D2 is set as in the following Formula (1):

$$D 1 > D 2 \qquad ( 1 )$$

With this configuration, even when the resin sheet 341 is worn, the conductive layer 343 does not contact the photosensitive drum surface, and a memory image can be prevented. This configuration is particularly effective for a photosensitive member unit having a long service life.

Further, it goes without saying that the conductive sheet 34 is disposed so that the end portion of the conductive layer 343 of the conductive sheet 34 on the photosensitive drum side is included within the region Sa surrounded by the broken line L2, the broken line L3, and the surface 61a of the photosensitive drum 61. Accordingly, the same effects as in the first embodiment are achieved.

Although the configuration of the present embodiment has been described by using the relationship of Formula (1) as an example, the relationship of Formula (1) does not necessarily need to be satisfied. For example, the distance D2 of the conductive sheet 34 may be set based on an amount of wear of the conductive sheet 34 and a cartridge service life, and the distance D2 may be equal to or less than the entering amount D1.

Further, the conductive layer 343 of FIG. 9B may be attached to the lower surface 610b of the frame 610.

Since the exposed portion 344 of the resin sheet is provided, a portion that contacts the photosensitive drum surface 61b is not the conductive layer 343 but the exposed portion 344 of the resin sheet.

In this case, when viewed from a gravity direction, the resin sheet overlaps the conductive layer on a downstream side in the conveyance direction of the recording medium, at the transfer nip of the conductive sheet, whereas the resin sheet does not overlap the conductive layer on an upstream side.

### Third Embodiment

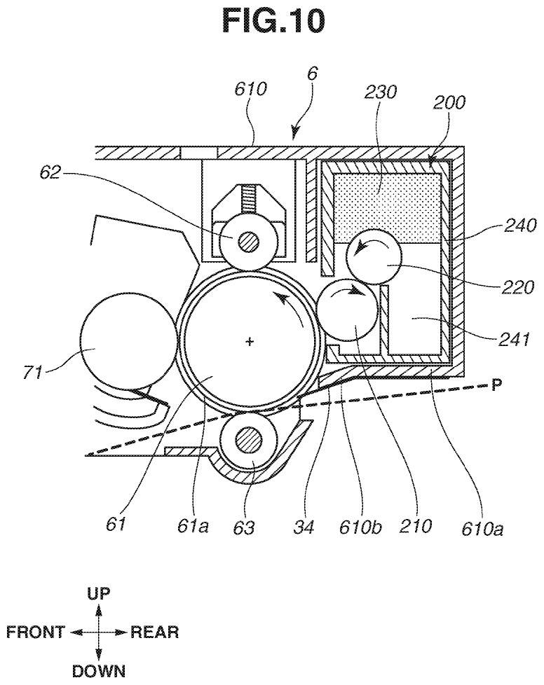

An embodiment according to the present disclosure will be described below with reference to the drawings. A third embodiment will be described with reference to FIG. 10. FIG. 10 illustrates a configuration in which a conductive sheet 34 is extended in a rearward direction on a lower surface of the photosensitive member unit.

The lower surface 610a of the photosensitive member unit may be charged. A supply source of electric charge that causes charging may be foreign matter or toner in the foreign matter storage portion 241, for example. Such charging of the lower surface 610a of the photosensitive member unit by foreign matter or toner is more unstable than charging of the photosensitive drum 61, and, in some cases, may increase a potential difference between the lower surface 610a of the photosensitive drum 61 and the sheet and strongly attract the sheet.

In view of this, a configuration in which the conductive sheet 34 is extended in the rearward direction on the lower surface of the photosensitive member unit is effective. An extended region in the rearward direction may include a region including a rearmost end portion of the foreign matter storage portion 241, which serves as a supply source of electric charge that causes charging. Limiting the extension region to the region including the rearmost end portion of the foreign matter storage portion 241 makes it possible to reduce an increase in cost to a minimum without unnecessarily increasing an amount of the conductive sheet 34 used.

The configuration also provides the effects even without grounding the conductive sheet 34 to the support of the photosensitive drum 61 as in the first embodiment. This is because a charging potential of the lower surface 610a of the photosensitive member unit 6 varies depending on a position, and the conductive sheet 34 averages the uneven surface potential.

While the first embodiment and the second embodiment define a position of the conductive sheet 34 on a photosensitive drum side, the present embodiment describes a position in the rearward direction. In the configuration of the first embodiment and the second embodiment as well, in a case where a rear portion of the conductive sheet 34 lies on the lower surface 610a of the photosensitive member unit, the conductive sheet 34 provides the effects even without grounding the conductive sheet 34 to the support of the photosensitive drum 61.

In the present embodiment, the conductive sheet 34 is described as being extended rearward as an integrated sheet, but a plurality of sheets functionally separated into a separation pawl and a rear portion other than the separation pawl may be used.

### Fourth Embodiment

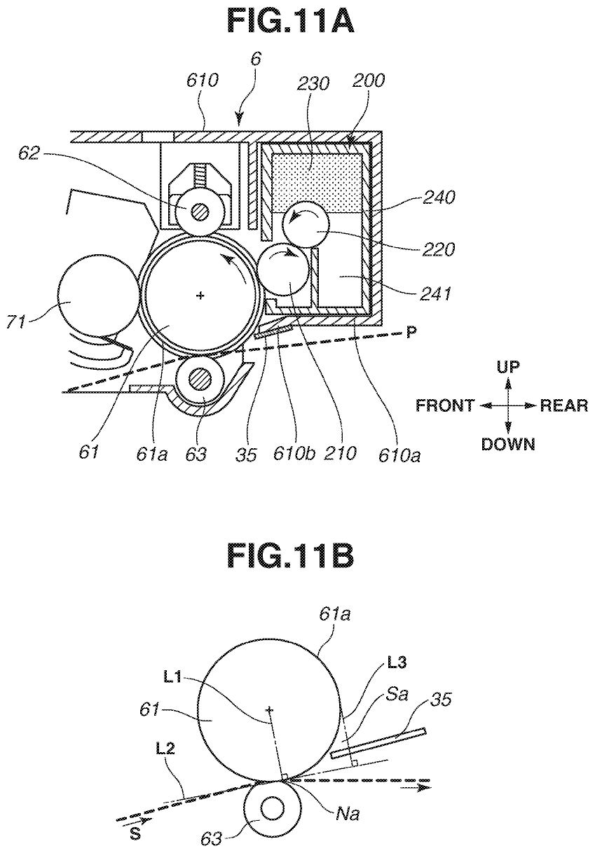

A fourth embodiment will be described with reference to FIGS. 11A and 11B. The present embodiment employs a configuration in which a conductive plate such as sheet metal is disposed near the photosensitive drum in a non-contact manner as a conductive member.

FIG. 11A illustrates a state in which a conductive plate (conductive sheet) 35 is disposed near the photosensitive drum 61. The conductive sheet 35 has the same configuration as in the first embodiment. An aluminum vapor-deposited film provided on the conductive sheet 35 is electrically connected to the support of the photosensitive drum 61. The conductive sheet 35 is disposed longitudinally in the rotation axis direction of the photosensitive drum 61, that is, extending in the left-right direction of the apparatus main body 2. The conductive sheet 35 is not in contact with the surface 61a of the photosensitive drum 61 and thus does not have a function of mechanically separating the sheet S, but the sheet S is separated from the surface 61a of the photosensitive drum 61 by a curvature of the photosensitive drum 61.

In this configuration, the aluminum vapor-deposited film of the conductive sheet 35 has the same potential as the support of the photosensitive drum 61, and an electrostatic force acting on the sheet S can be reduced as in the first embodiment. Accordingly, the electrostatic force acting on the sheet S is weakened, conveyance of the sheet S is stabilized, and occurrence of image disturbance and the like can be suppressed.

FIG. 11B is a diagram illustrating, in order to describe a tip position of the conductive sheet 35, main members near the transfer nip extracted from FIG. 11A.

The tip position of the conductive sheet 35 near the photosensitive drum 61 is disposed within the region Sa surrounded by a broken line L2, a broken line L3, and the surface 61a of the photosensitive drum 61. Here, the broken line L2 is a tangent line to the photosensitive drum 61 at the downstream end portion Na of the transfer nip. Further, the broken line L3 is a tangent line that is perpendicular to the broken line L2 and is in contact with the photosensitive drum 61, the tangent line being downstream of the transfer nip.

Disposing the tip of the conductive sheet 35 at least above the broken line L2 prevents a conveyance failure in which the sheet enters between the conductive sheet 35 and the photosensitive drum 61. Further, in order to reduce an electrostatic force between the sheet and the photosensitive drum 61, disposing the tip position of the conductive sheet 35 at least closer to the surface 61a of the photosensitive drum 61 than the broken line L3 prevents image disturbance and contamination of the conveyance path.

In the present embodiment, arranging the conductive layer so as not to contact the photosensitive drum provides a distinctive effect of preventing surface scratches on the photosensitive drum and memory images due to sliding contact.

A desirable form of disposing the tip of the conductive sheet 35 has been described above, and, in the description, the region Sa has been defined with the downstream end portion Na of the transfer nip N as an origin. In the present embodiment in which the frame 610 of the photosensitive member unit 6 supports the transfer roller 63, variation in a position of the downstream end portion Na of the transfer nip on the photosensitive drum can be reduced. Accordingly, accuracy in confining the conductive sheet 35 to a desired region Sa is improved. Needless to say, even in a configuration in which the apparatus main body includes the transfer roller, confining the conductive plate 35 to the region Sa provides the same effect.

The conductive sheet 35 is the insulating resin sheet 341 having the metal film 343 on one surface.

The conductive sheet 35 is disposed such that the resin sheet 341 faces the surface 61a of the photosensitive drum 61. The metal film 343 is formed on the surface of the resin sheet 341 opposite to the surface on the side on which the photosensitive drum 61 is located. Thus, the conductive sheet 35 has a two-layer structure including the resin sheet 341 and the metal film 343.

Assume that a tip of the conductive sheet 35 contacts the photosensitive drum 61. In such a case, contact of the metal film 343 causes electric charge of the photosensitive drum 61 to leak at the contact point, and the surface potential of the photosensitive drum 61 becomes non-uniform. If this non-uniformity is not eliminated in a charging process, a defect such as drum ghosting may become apparent in a printed image.

However, with the configuration of the present embodiment, even if a tip of the conductive sheet 35 contacts the photosensitive drum 61, the portion that contacts the photosensitive drum 61 is a portion of the insulating resin sheet 341, thereby preventing the defect described above.

The present disclosure is not limited to the above embodiments, and various changes and modifications can be made without departing from the spirit and scope of the present disclosure. Accordingly, the following claims are appended to disclose the scope of the present disclosure.

According to the present disclosure, it is possible to provide a new form of an image forming apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image forming apparatus that forms an image on a recording material, comprising:
a photosensitive drum configured to bear a toner image;
a frame configured to rotatably support the photosensitive drum;
a sheet member having one end that is a free end and another end fixed to the frame; and
a transfer roller configured to contact the photosensitive drum to form a transfer nip and configured to transfer the toner image onto the recording material when the recording material is conveyed and passes through the transfer nip,
wherein the sheet member includes a conductive layer and an insulating layer and is provided on a downstream side in a conveyance direction of the recording material at the transfer nip,
wherein, when viewed in a thickness direction of the sheet member, the conductive layer and the insulating layer overlap at least partially, and
wherein the insulating layer is closer to the photosensitive drum than the conductive layer and is disposed to face a surface of the photosensitive drum,
and wherein the conductive layer is electrically grounded.

2. The image forming apparatus according to claim 1, wherein the one end is an end portion of the insulating layer and contacts the surface of the photosensitive drum.

3. The image forming apparatus according to claim 1, wherein the conductive layer is electrically grounded, via a support of the photosensitive drum.

4. The image forming apparatus according to claim 1,
wherein the photosensitive drum includes a cylindrical support having conductivity and a photosensitive layer supported by the support and formed on a surface of the support, and
wherein the support and the conductive layer are electrically connected to each other.

5. The image forming apparatus according to claim 1, wherein the insulating layer is fixed to the frame, and the conductive layer is provided on a side of the insulating layer opposite to a side that contacts the photosensitive drum.

6. The image forming apparatus according to claim 1,
wherein the conductive layer is fixed to the frame, and the insulating layer is provided on a side of the conductive layer opposite to a side that contacts the photosensitive drum, and
wherein, when viewed in a gravity direction, in the conveyance direction of the recording material at the transfer nip, the insulating layer overlaps the conductive layer on a downstream side, and the insulating layer does not overlap the conductive layer on an upstream side.

7. The image forming apparatus according to claim 1, further comprising:
a cleaning member configured to collect toner not transferred to the recording material from the photosensitive drum and configured to clean the photosensitive drum; and
a storage portion configured to accommodate the toner collected by the cleaning member,
wherein, when viewed in a gravity direction, the other end overlaps the storage portion.

8. The image forming apparatus according to claim 1,
wherein a material of the conductive layer includes at least one of metal and carbon black, and
wherein a material of the insulating layer includes at least one of polyester, polyethylene naphthalate, polycarbonate, polyvinylidene fluoride, polyethylene, polypropylene, polystyrene, polyamide, polyarylate polyethylene naphthalate, polybutylene naphthalate, and thermoplastic polyimide.

9. The image forming apparatus according to claim 1, further comprising an apparatus main body and a cartridge configured to be attachable to and detachable from the apparatus main body, wherein the cartridge includes the photosensitive drum, the frame, and the sheet member.

10. The image forming apparatus according to claim 9, further comprising:
a cleaning member configured to collect toner not transferred to the recording material from the photosensitive drum and configured to clean the photosensitive drum; and
a storage portion configured to store the toner collected by the cleaning member,
wherein the transfer roller, the cleaning member, and the storage portion are integrally supported by the frame and are included in the cartridge.

11. The image forming apparatus according to claim 1, wherein a surface resistivity of the conductive layer is 1.0×10⁶ Ω/sq or less, and wherein a volume resistivity of the insulating layer is 1.0×10⁸ Ω·cm or more.

12. The image forming apparatus according to claim 1, wherein a thickness of the conductive layer is 0.1 μm or more and 0.5 μm or less, and a thickness of the insulating layer is 40 μm or more and 200 μm or less.

13. The image forming apparatus according to claim 1, wherein, in a range in which the sheet member is provided in a direction of a rotation axis of the photosensitive drum, the sheet member contacts the surface of the photosensitive drum at a first position, and the sheet member does not contact the surface of the photosensitive drum at a second position.

14. The image forming apparatus according to claim 1, wherein, when viewed from a direction of a rotation axis of the photosensitive drum, in the conveyance direction of the recording material at the transfer nip, in a case where a tangent line passing through a downstream end point of the transfer nip and being in contact with an outer circumference of the photosensitive drum is defined as a first imaginary line, and a tangent line that is orthogonal to the first imaginary line and in contact with the outer circumference of the photosensitive drum, the tangent line being located on a downstream side in the conveyance direction of the recording material at the transfer nip, is defined as a second imaginary line, at least a part of the conductive layer overlaps a region surrounded by the first imaginary line, the second imaginary line, and the outer circumference.

15. A drum cartridge configured to be attachable to and detachable from an image forming apparatus that forms an image on a recording material, comprising:
a photosensitive drum configured to bear a toner image;
a frame configured to rotatably support the photosensitive drum;
a sheet member having one end that is a free end and another end fixed to the frame; and
a transfer roller configured to contact the photosensitive drum to form a transfer nip and configured to transfer the toner image onto the recording material when the recording material passes through the transfer nip,
wherein the sheet member includes a conductive layer and an insulating layer and is provided on a downstream side in a conveyance direction of the recording material at the transfer nip,
wherein, when viewed in a thickness direction of the sheet member, the conductive layer and the insulating layer overlap at least partially, and
wherein the insulating layer is disposed to face a surface of the photosensitive drum.

16. The drum cartridge according to claim 15, wherein, in a case where the frame is referred to as a first frame, a developing cartridge including:
a developing roller configured to develop an electrostatic latent image on the photosensitive drum; and
a second frame configured to rotatably support the developing roller is configured to be detachably attachable.
